(19) United States
(12) Patent Application Publication
(10) Pub. No.: US 2025/0271583 A1
(43) Pub. Date: Aug. 28, 2025

(54) CONTROL DEVICE AND CONTROL METHOD

(71) Applicant: Nippon Telegraph and Telephone Corporation, Tokyo (JP)

(72) Inventors: Yuichiro OKUGAWA, Musashino-shi, Tokyo (JP); Hidenori IWASHITA, Musashino-shi, Tokyo (JP); Yoshiharu HIROSHIMA, Musashino-shi, Tokyo (JP)

(21) Appl. No.: 18/858,815

(22) PCT Filed: May 12, 2022
(86) PCT No.: PCT/JP2022/020050

§ 371 Date: Oct. 22, 2024

(51) Int. Cl. G01T 1/29; B64G 1/54; G01T 1/20

(52) U.S. Cl. CPC G01T 1/2907; B64G 1/54; G01T 1/20

(57) ABSTRACT

A control device 20 includes a processing unit 21 configured to determine an incoming direction of radiation by a detector 10 using a scintillator; and a control unit 22 configured to control a solenoid coil such that a magnetic null point does not face the incoming direction of the radiation.

### TECHNICAL FIELD

The present invention relates to a control device and a control method.

### BACKGROUND ART

Various types of radiation are present in outer space (for example, protons, heavy particles and gamma radiation) and generated from a variety of sources (for example, the Sun, the galaxy, supernova explosions and gamma bursts), and thus radiation comes from various directions. Therefore, artificial satellites, communication satellites, probes, and living bodies (including human bodies) in space are affected by radiation, leading to malfunction, life shortening, and other radiation hazards due to exposure. A method has been proposed in which a strong magnetic field is generated by a solenoid coil of a solenoid magnetic field generator, and the influence of cosmic radiation on equipment and living bodies is reduced by a barrier due to the strong magnetic field (Non Patent Literature 1).

### CITATION LIST

### Non Patent Literature

Non Patent Literature 1: Romain Bruce, et al., “Cryogenic Design of a Large Superconducting Magnet for Astro-particle Shielding on Deep Space Travel Missions”, Physics Procedia, Vol. 67, 2015, doi: 10.1016/j.phpro.2015.06.085, p. 264-p. 269

### SUMMARY OF INVENTION

### Technical Problem

However, since a magnetic field distribution of the solenoid coil has a portion with a weaker magnetic field intensity (which is called “magnetic null point”), the equipment and living bodies cannot be sufficiently protected from the radiation coming from various directions.

The present invention has been made to address such problems, and an object of the present invention is to provide a technology capable of reliably protecting devices and living bodies from radiation coming from various directions.

### Solution to Problem

According to one aspect of the present invention, a control device includes a processing unit configured to determine an incoming direction of radiation by a detector using a scintillator; and a control unit configured to control a solenoid coil such that a magnetic null point does not face the incoming direction of the radiation.

According to one aspect of the present invention, a control method executed by a control device includes: determining an incoming direction of radiation by a detector using a scintillator; and controlling a solenoid coil such that a magnetic null point does not face the incoming direction of the radiation.

### Advantageous Effects of Invention

According to the present invention, it is possible to provide a technology capable of reliably protecting devices and living bodies from radiation coming from various directions.

### BRIEF DESCRIPTION OF DRAWINGS

FIG. 1 is a diagram illustrating a configuration example of a control system.

FIG. 2 is a diagram illustrating a configuration example of a detector.

FIG. 3 is a diagram illustrating an operation flow of the control device.

FIG. 4 is a diagram illustrating an example of radiation incoming direction.

FIG. 5 is a diagram illustrating an example of a time difference between light emission peaks.

FIG. 6 is a diagram illustrating an example of radiation incoming direction (including a falsely determined path).

FIG. 7 is a diagram illustrating an example of the number of radiation path determinations.

FIG. 8 is a diagram illustrating a control example of a solenoid magnetic field generator.

FIG. 9 is a diagram illustrating a hardware configuration example of the control device.

### DESCRIPTION OF EMBODIMENTS

Embodiments of the present invention will be described hereinbelow with reference to drawings. In the drawings, the same components are denoted by the same reference symbols, and the descriptions thereof are omitted.

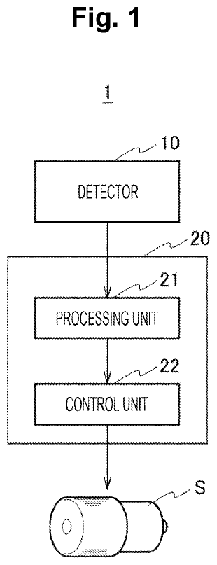

FIG. 1 is a diagram illustrating a configuration example of a control system 1 according to the present embodiment. The control system 1 includes a detector 10 that detects radiation, and a control device 20 that controls a solenoid magnetic field generator S based on the radiation detected by the detector 10.

The control device 20 can establish communication with each of the detector 10 and the solenoid magnetic field generator S. The control device 20 includes a processing unit 21 that determines an incoming direction and energy of radiation by the detector 10, and a control unit 22 that controls a solenoid coil of the solenoid magnetic field generator S such that a magnetic null point does not face the incoming direction of the radiation. The control device 20 may be configured outside the detector 10 or may be configured inside the detector 10.

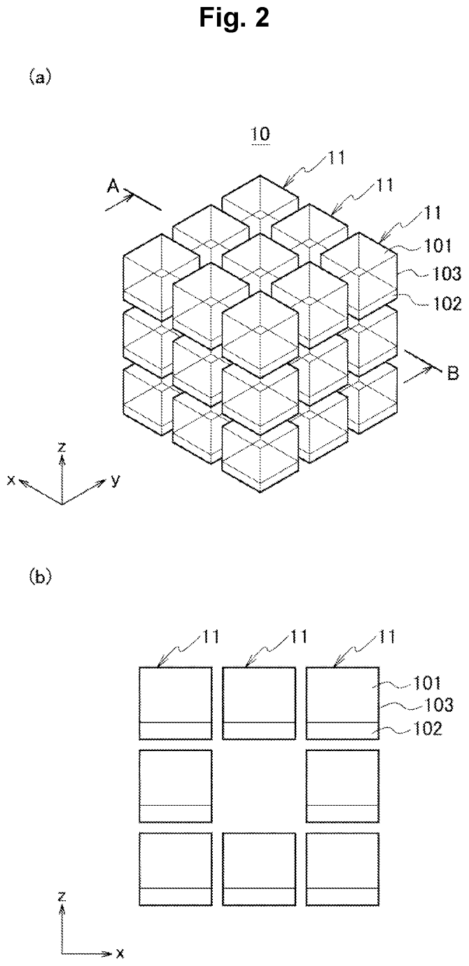

FIG. 2 is a diagram illustrating a configuration example of the detector 10. FIG. 2(a) is an external view of the detector 10. FIG. 2(b) is a cross-sectional view taken along line A-B of FIG. 2(a).

The detector 10 includes a plurality of rectangular parallelepiped sensors 11 that detect radiation. For example, the detector 10 includes a 3×3×3 sensor group in which three sensors 11 are arranged in each of a lateral direction (x-axis), a depth direction (y-axis) and a height direction (z-axis). However, as illustrated in FIG. 2(b), the sensor group has hollow central portions and the number of sensors in the sensor group is actually 26.

Each of the sensors 11 includes a scintillator 101 that emits light beams by a nuclear reaction due to incidence of radiation, a photomultiplier 102 that amplifies light emission of the scintillator 101, and a light-shielding thin film 103 that removes an influence of light incidence due to light emission in another scintillator 101 within the detector 10. Accordingly, each sensor 11 has a function of individually emitting light beams when radiation is incident and amplifying the emitted light.

Note that the 3×3×3 sensor group is an example of the detector 10. The detector 10 may include a 3×4×5 sensor group or a 5×5×5 sensor group. As the number of sensors is increased, radiation trapping capability improves.

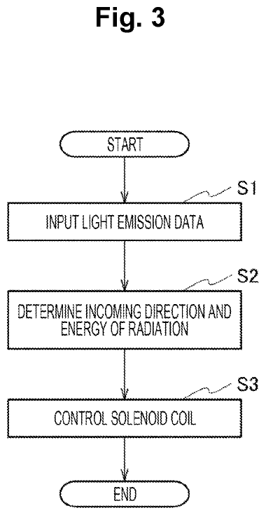

FIG. 3 is a diagram illustrating an operation flow of the control device 20.

### Step S1:

The processing unit 21 inputs light emission data detected by the sensor 11 of the detector 10.

### Step S2:

The processing unit 21 determines a radiation incoming direction and energy by using the input light emission data. Specifically, the processing unit 21 determines the incoming direction and energy of the radiation incident on the detector 10 based on positions of the two sensors 11 that have detected the light emission and a time difference between the light emission peaks of the two sensors 11.

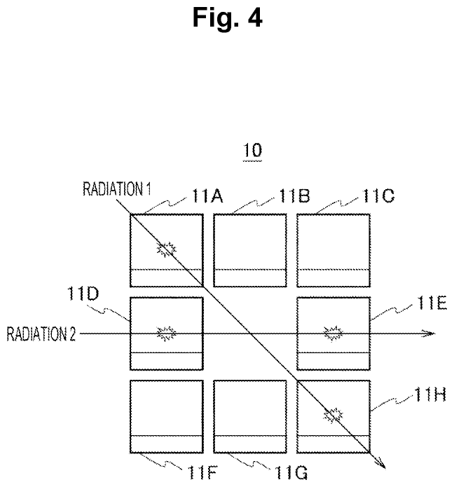

The processing unit 21 determines the radiation incoming direction according to a direction extending from a line segment connecting the two sensors 11 that have detected light emission. For example, as illustrated in FIG. 4, in a case where a sensor 11A and a sensor 11H emit light beams at a certain timing, the processing unit 21 sets a direction extending from a straight line passing through positions of the sensors 11A and 11H as an incoming direction of radiation 1. Similarly, in a case where a sensor 11D and a sensor 11E emit light beams at a certain timing, the processing unit 21 sets a direction extending from a straight line passing through positions of the sensors 11D and 11E as an incoming direction of radiation 2.

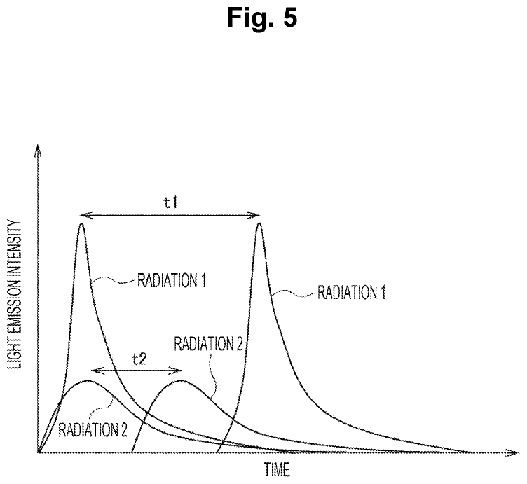

The processing unit 21 determines the energy of the radiation based on the time difference between the light emission peaks of the two sensors 11 that have detected the light emission. For example, as illustrated in FIG. 5, the processing unit 21 determines the radiation 1 by a time difference t1 between the light emission peak in the sensor 11A and the light emission peak in the sensor 11H. Similarly, the processing unit 21 determines the radiation 2 by a time difference t2 between the light emission peak in the sensor 11D and the light emission peak in the sensor 11E. Since the radiation becomes closer to the speed of light as the energy becomes higher, the energy can be determined by determining a time taken by the radiation to travel a known distance between the sensors 11.

The processing unit 21 further determines the type of radiation. For example, the processing unit 21 discriminates the type of radiation by analyzing the light emission characteristics (e.g. changes in emission intensity over time).

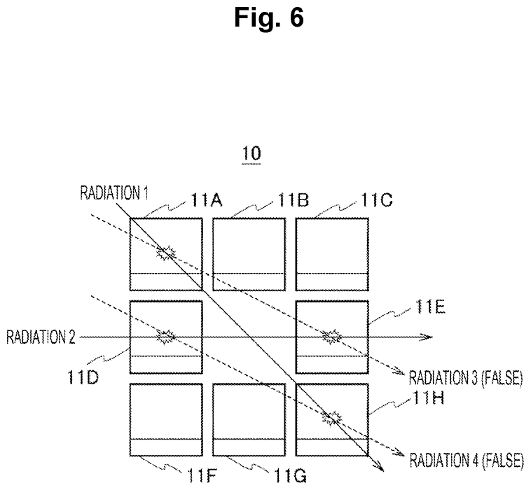

An operation in a case where the radiation 1 and the radiation 2 are incident at substantially the same timing will be described. In this case, since the sensor 11A and the sensor 11D emit light beams substantially at the same time and the sensor 11E and the sensor 11H emit light beams substantially at the same time, as illustrated in FIG. 6, false paths such as radiation (radiation 3) passing through the sensor 11A and the sensor 11E or radiation (radiation 4) passing through the sensor 11D and the sensor 11H may be identified, and it becomes difficult to determine the radiation incoming direction.

Meanwhile, the cosmic radiation has the characteristic of continuously incidence from a specific direction. Therefore, the processing unit 21 determines a radiation path connecting two sensors 11 among four sensors emitting due to the radiation with a straight line, and determines an incoming direction in which the radiation comes from based on the number of path determinations.

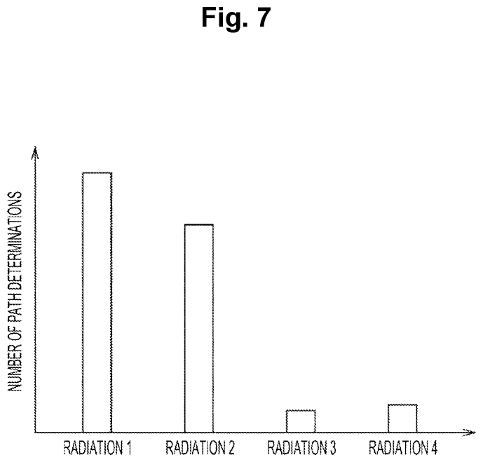

For example, the processing unit 21 determines the actual incoming direction by obtaining the numbers of path determinations (sum value) and comparing them with each other as illustrated in FIG. 7, where a linear path of the sensor 11A and the sensor 11H is a path of the radiation 1, a linear path of the sensor 11D and the sensor 11E is a path of the radiation 2, a linear path of the sensor 11A and the sensor 11E is a path of the radiation 3, and a linear path of the sensor 11D and the sensor 11H is a path of the radiation 4. Since the radiation 3 and the radiation 4 have an extremely small number of path determinations, it is determined that the paths have been erroneously determined.

### Step S3:

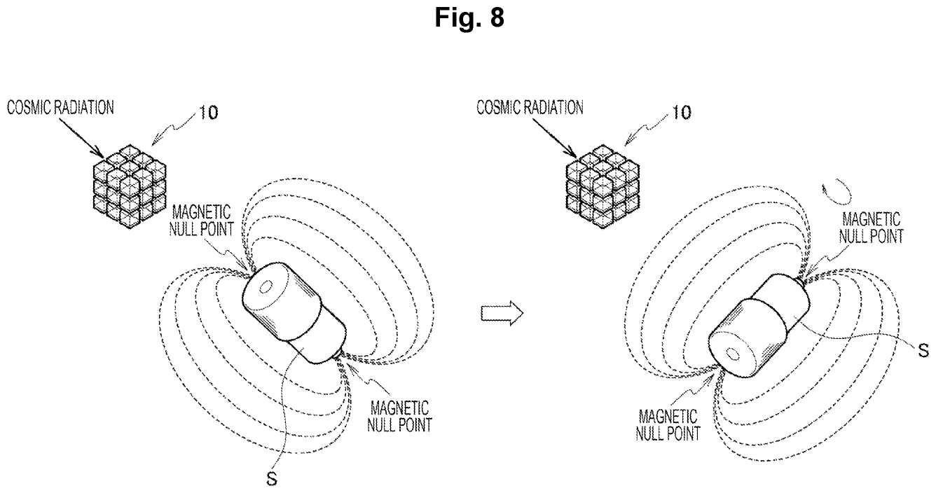

Finally, the control unit 22 controls the solenoid magnetic field generator S based on the radiation incoming direction, the energy, and the type determined by the processing unit 21. For example, as illustrated in FIG. 8, the control unit 22 changes a direction of a strong magnetic field barrier by the solenoid coil based on the radiation incoming direction so that a magnetic null point does not face the radiation incoming direction. The control unit 22 changes a strength of the strong magnetic field barrier on the basis of the energy and type of the radiation. The control unit 22 optimizes the direction and strength of the strong magnetic field barrier to maximize the effects of the strong magnetic field barrier.

According to the present embodiment, the control device 20 determines the radiation incoming direction and energy by the detector 10 using the scintillator, and controls the solenoid coil of the solenoid magnetic field generator S such that the magnetic null point does not face the radiation incoming direction. Therefore, it is possible to provide a technology capable of more reliably protecting equipment and living bodies from radiation coming from various directions.

The present invention is not limited to the above embodiments. The present invention may be altered or modified in various manners without departing from the gist of the present invention.

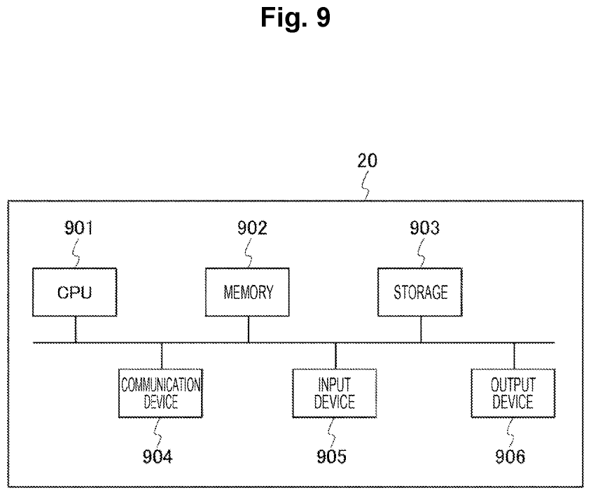

For example, as illustrated in FIG. 9, the control device 20 of the present embodiment described above can be implemented using a general-purpose computer system including a CPU 901, a memory 902, a storage 903, a communication device 904, an input device 905, and an output device 906. The memory 902 and the storage 903 are storage devices. In the computer system, each function of the control device 20 is implemented by the CPU 901 executing a predetermined program loaded on the memory 902.

The control device 20 may be implemented by a single computer. The control device 20 may be implemented by a plurality of computers. The control device 20 may be a virtual machine implemented on a computer. The program for the control device 20 can be stored in a computer-readable recording medium such as HDD, SSD, USB memory, CD, or DVD. The program for the control device 20 can also be distributed via a communication network.

### REFERENCE SIGNS LIST

1 Control system
10 Detector
11 Sensor
101 Scintillator
102 Photomultiplier tube
103 Light shielding thin film
20 Control device
21 Processing unit
22 Control unit
901 CPU
902 Memory
903 Storage
904 Communication device
905 Input device
906 Output device

1. A control device comprising:
a processing unit, including one or more processors, configured to determine an incoming direction of radiation by a detector using a scintillator; and
a control unit, including one or more processors, configured to control a solenoid coil such that a magnetic null point does not face the incoming direction of the radiation.

2. The control device according to claim 1, wherein
the detector includes a plurality of scintillators, and
the processing unit is configured to determine an incoming direction of radiation based on positions of two scintillators that emit light beams by the radiation.

3. The control device according to claim 1, wherein
the detector includes a plurality of scintillators, and
the processing unit is configured to determine energy of radiation based on a time difference between light emission peaks of two scintillators that emit light beams by the radiation.

4. The control device according to claim 1, wherein
the detector includes a plurality of scintillators, and
the processing unit is configured to determine a path of radiation linearly connecting two scintillators emitting light beams due to the radiation, and determine an incoming direction of the radiation based on the number of path determinations.

5. The control device according to claim 1, wherein the detector includes a plurality of scintillators arranged in a lateral direction, a depth direction, and a height direction, the scintillators having hollows therebetween.

6. A control method executed by a control device, the method comprising:
determining an incoming direction of radiation by a detector using a scintillator; and
controlling a solenoid coil such that a magnetic null point does not face the incoming direction of the radiation.

7. The control method according to claim 6, wherein
the detector includes a plurality of scintillators, and
the control method further comprises determining an incoming direction of radiation based on positions of two scintillators that emit light beams by the radiation.

8. The control method according to claim 6, wherein
the detector includes a plurality of scintillators, and
the control method further comprises determining energy of radiation based on a time difference between light emission peaks of two scintillators that emit light beams by the radiation.

9. The control method according to claim 6, wherein
the detector includes a plurality of scintillators, and
the control method further comprises determining a path of radiation linearly connecting two scintillators emitting light beams due to the radiation, and determining an incoming direction of the radiation based on the number of path determinations.

10. The control method according to claim 6, wherein the detector includes a plurality of scintillators arranged in a lateral direction, a depth direction, and a height direction, the scintillators having hollows therebetween.
